(19) United States
(12) Patent Application Publication
(10) Pub. No.: US 2009/0171744 A1
(43) Pub. Date: Jul. 2, 2009

(54) System and method for reducing employee training time and distributing corporate and job information to employees

(76) Inventors: Richard L. Hake, Overland Park, KS (US); Marc E. McConathy, Leawood, KS (US); Michael L. Diehl, Lee's Summit, MO (US); Timothy R. Samoff, Kansas City, MO (US); Mickey H. DeHook, Olathe, KS (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 12/005,762

(22) Filed: Dec. 28, 2007

(51) Int. Cl. G06Q 10/00

(52) U.S. Cl. 705/9; 705/1

(57) ABSTRACT

A system and method for communicating corporate information to employees of a company which may include creating an employee user profile that includes an identifier of a job position of the employee within a company. Corporate information to be communicated to employees of the company may be identified. Distribution information may be assigned to the corporate information, where the distribution information may include an identifier associated with at least one job position to communicate the corporate information. The corporate information may be pushed to employees associated with the distribution information, where the pushed corporate information may cause the corporate information to be presented to the employee.

### BACKGROUND

New employees of companies or corporations typically attend orientation training courses generally to learn about corporations, to be trained on corporate software applicable to their particular jobs, and to learn about company products and services. Depending on the size of the company, scope of employment, and company products and services, the orientation training courses may last anywhere from a few hours to a few weeks. Even after an employee attends the orientation training classes, it may be several weeks or months until an employee becomes comfortable with his or her job responsibilities, software, department efforts, and corporate policies.

While the cost of training and integrating new employees into their jobs can be expensive for companies, the challenge is ensuring that each employee understands current policies, procedures, job description changes, changes to products and services, and so forth. The faster the pace of a company and management decisions that affect employees and their job functions, the more important it is to distribute corporate information updates to employees. There are several conventional ways that corporation information is distributed to employees, including memos on paper, e-mail, posts on intranet or Internet websites, and staff meetings. Even with these different forms of communication, employees often are at a disadvantage to keeping up with reading every piece of paper, e-mail, or remembering details that were presented to them about the corporate information. Because of the difficulties in distributing corporate information, employees may perform their jobs using antiquated information or, in the case of new employees, be inefficient at their jobs for an overly extensive period of time until they learn their job responsibilities, software, and corporate information. As understood by corporations, distribution of corporation information for both new and experienced employees remains a challenge for all companies due to employee and management communications limitations.

### SUMMARY

To reduce the costs of training new employees, increase efficiency of new employees, and improve corporate information distribution, the principles of the present invention provide for using push communications technology to more easily and efficiently enable employees to access corporate information. The push communications technology may actively reside on employees' computers and be configured such that each employee receives information relevant to his or her job function within a company. Each employee may be classified with a certain job title, group, department, region, and/or otherwise so that meaningful corporate information can be filtered and displayed for each employee, thereby reducing time that an employee has to review the corporate information (i.e., non-relevant information would be minimized for each employee). By pushing corporate information to employees, orientation training time is reduced, efficiency of employee learning is increased, and corporate information distribution is improved over conventional corporate information communication techniques.

One embodiment of a method for communicating corporate information to employees of a company may include creating an employee user profile that includes an identifier of a job position of the employee within a company. Corporate information to be communicated to employees of the company may be identified. Distribution information may be assigned to the corporate information, where the distribution information may include an identifier associated with at least one job position to communicate the corporate information. The corporate information may be pushed to employees associated with the distribution information, where the pushed corporate information may cause the corporate information to be presented to the employee.

One method for training new employees may include presenting a first portion of new employee training information to a new employee in an organized classroom setting. The new employee may be deployed into a job position. A second portion of new employee training information maybe pushed to the new employee to complete training the new employee.

An embodiment of a system for communicating corporate information to employees of a company may include a communications network configured to communicate corporate information to employees within a company. A corporate information database may be configured to store corporate information. An application server may be in communication with the communications network and database. A push communication application may be executed by the application server. The push communication application may be configured to access corporate information stored in the corporate information database and push the accessed corporate information to selectable employees within the company for display thereto.

### BRIEF DESCRIPTION OF THE DRAWINGS

Illustrative embodiments of the present invention are described in detail below with reference to the attached drawing figures, which are incorporated by reference herein and wherein:

FIG. 1 is a block diagram of an exemplary organizational chart of a company:

FIG. 2 is a block diagram of an exemplary network that provides data communications to employees at a company;

FIG. 3 is a screenshot of an exemplary graphical user interface including a push technology interface in which corporate information may be displayed in response to being pushed to an employee;

FIG. 4 is a block diagram of exemplary modules for use in managing and controlling corporate information being pushed to employees;

FIG. 5 is a flowchart of an exemplary process for pushing corporate information to employees; and

FIG. 6 is a flowchart of an exemplary process for training new employees.

### DETAILED DESCRIPTION OF THE DRAWINGS

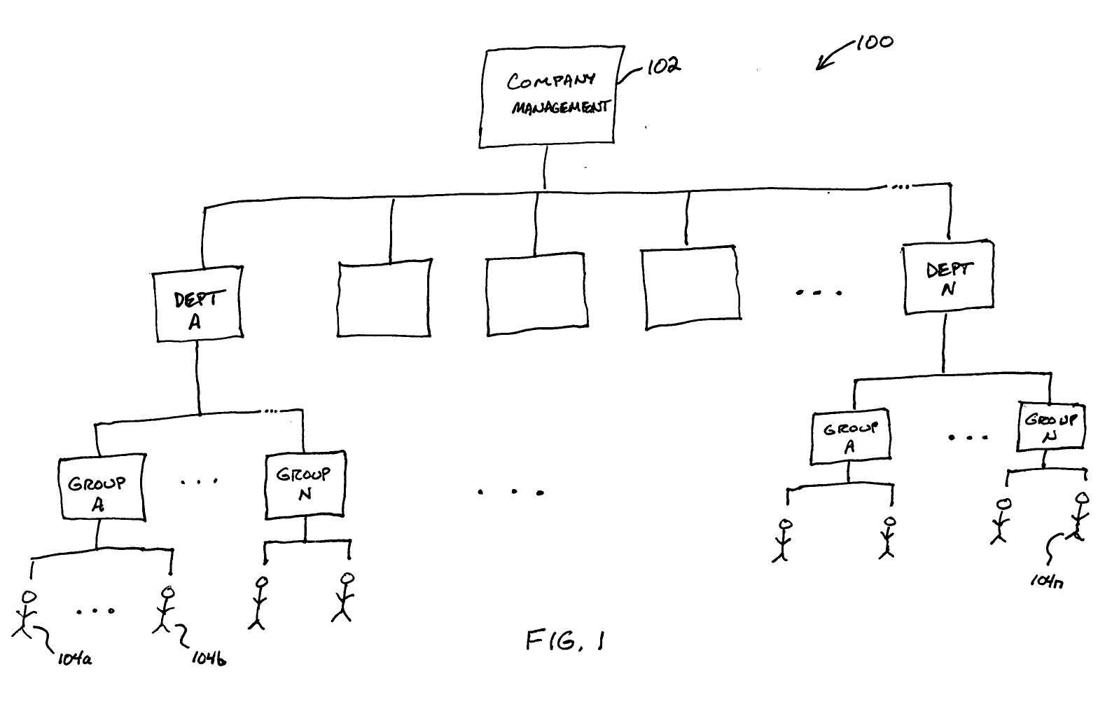

FIG. 1 is a block diagram of an exemplary organizational chart 100 of a company. As shown on the organizational chart 100, company management 102 operates as a leadership position over each of the departments A-N, which may further be divided into groups A-N below each department. Within each group is employees 104a-104n (collectively 104) that are assigned to a group within a department. It should be understood that the organizational chart 100 is exemplary and that other configurations of a company may be represented by an organizational chart.

Corporate communications are important for a company to distribute corporate information. The corporate information may include new employee information, training information, updates on products and services, such as pricing schedules, and any other information with which employees may find helpful in conducting their jobs. For efficiency purposes, and for purposes of motivating an employee to review the corporate information, push technology may be employed by the company to push information to employees via a computer network In one embodiment, push technology may include the use of really simple syndication (RSS) technology that causes information to be displayed on a user computer display in an automatic fashion on a “feed reader.”

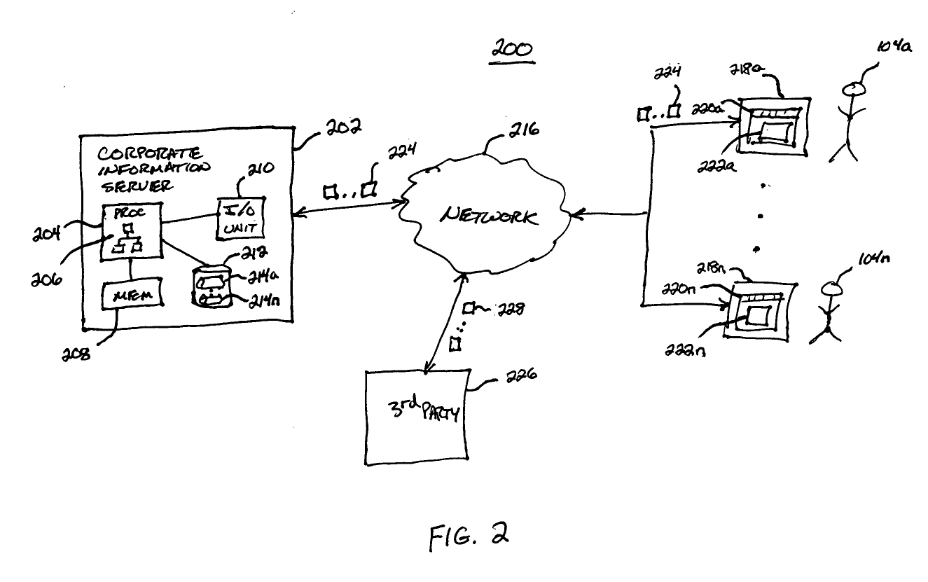

FIG. 2 is a block diagram of an exemplary network 200 that provides data communications to employees at a company. The network 200 may include a corporate information server 202 that is configured to operate as a central or distributed serving point from which to distribute corporate information. The corporate information server 202 may include a processor 204 that executes software 206. The software 206 may be used to collect corporate information and operate an application that pushes the corporate information to employees 104 of the company. The processor 204 may be in communication with a memory 208 as configured to store corporate information and other information for use in pushing the corporate information to the employees 104. The processor 204 may further be in communication with an input/output (I/O) unit 210, which may be configured to communicate data remotely from the corporate information server 202, and a storage unit 212 that may store one or more data repositories 214a-214n (collectively 214) for storing corporate information and/or employee information. In one embodiment, the software 206 maybe configured to access the corporate and employee information stored in the data repositories 214. In one embodiment, the data repositories 214 are configured as a single or multiple databases. The databases may be relational databases or use other configurations of databases, as understood in the art.

A network 216, which may be an intranet, Internet or any other form of data communication networks, may be used by the corporate information server 202 for communicating of the corporate information using push technology to the employees 104. The employees 104 may each have a computing device 218a-218n (collectively 218), such as a personal computer or other computing device, with which each of the employees 104 use to perform their job functions. Each of the computing devices 218 may have an application operating thereon that is configured to receive corporate information pushed to the respective computing device 218. In one embodiment, graphical user interfaces 220a-220n (collectively 220) may be presented to each of the employees 104. In one embodiment, the graphical user interfaces 220 operates as an operating system. A region of the graphical user interface 220 provides for a push technology interface 222a-222n (collectively 222), which is conventionally known as a reader that enables a user to interface with the information being displayed. In the push technology interface 222, corporate information pushed to respective employees may be displayed and available for respective employees to view and access. In one embodiment, the corporate information may be communicated by the corporate information 202 via the network 216 using data packets 224, as understood in the art.

While corporate information may be generated within a company, it should be understood that corporate information may be created by a third-party 226 (i.e., from individuals or companies external from the company), and stored in the data repositories 214 for use in communicating to employees 104. For example, the third-party 226 may generate user instruction information for software, products, or other items with which the employees 104 use or sell in their particular job functions. For example, an employee may use a custom designed software package, such as a billing system, sales tracking system, or otherwise, that is produced by the third-party 226 and the user's manual updates may be pushed to employees that work with the particular software associated with the information produced by the third-party 226.

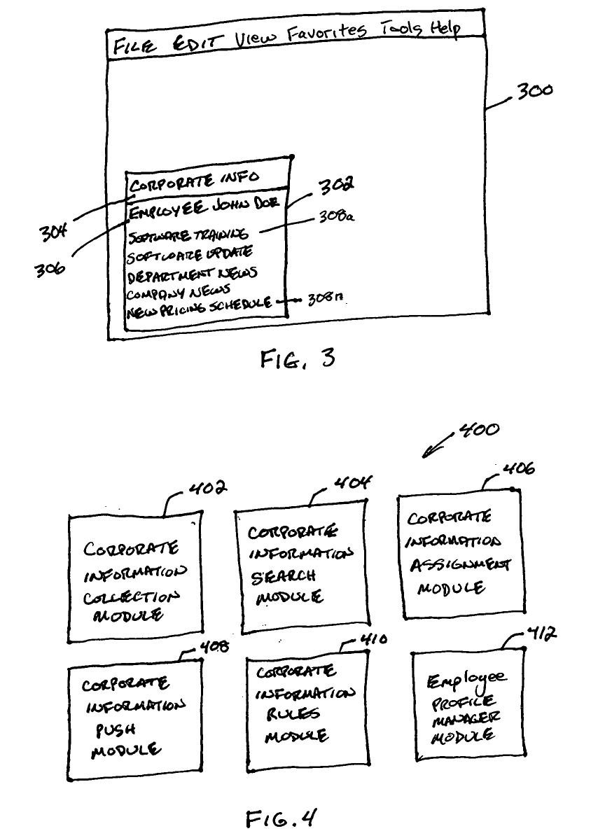

FIG. 3 is a screenshot of an exemplary graphical user interface 300 including a push technology interface region 302 in which corporate information may be displayed in response to being pushed to an employee. The push interface region 302 may include a title 304, employee name 306, and corporate information 308a-308n (collectively 308). Other information, such as employee job title, may be displayed. As shown, the corporate information 308 is shown as general topics, including “software training,” “software update,” “department news,” “company news,” and “new pricing schedule.” Each of these topics may be configured in any presentable manner such that information is displayed with or without the need for a user to interface with the push interface region 302. For example, the new pricing schedule may show products and current prices that are updated on an ongoing basis. In one embodiment, the different topics maybe selectable such that a user may select a topic of interest. For example, if software training has an update, the words “software training” may be presented in a different color or with a different background, for example, to indicate to an employee that new information is available in the software training. The same or similar functionality may be applied to each of the different topics displayed in the push interface region 302. Although shown as text, it should be understood that any icon, graphics, or other indicia maybe utilized to signify to an employee the topic. The push interface region 302 may be selectably changed in size to be larger, smaller, or hidden, as understood in the art. In one embodiment, the push interface region 302 may be hidden and an icon may be “floated” in a corner of a user's desktop to enable the employee to selectively open the push interface region 302. The corporate information is continuously pushed to employees and the employees may easily access the information in a dedicated region of his or her computing device. In an alternative embodiment, rather than having a selectable indicia (e.g., word or graphic), the actual corporate information may be displayed in part (e.g., headline) or in full (e.g., headline, text, graphics).

As an example of corporate information, a company may distribute new pricing information to customer service representatives. The most recent corporate information may remain posted to the push interface region 302 and then a selectable archive indicia (e.g., text link may remain for employees to access the information.
Computer Monitor Model XYZ now $749
Computer Monitor Model ABC now $849
Computer Monitor Model QRS now $599

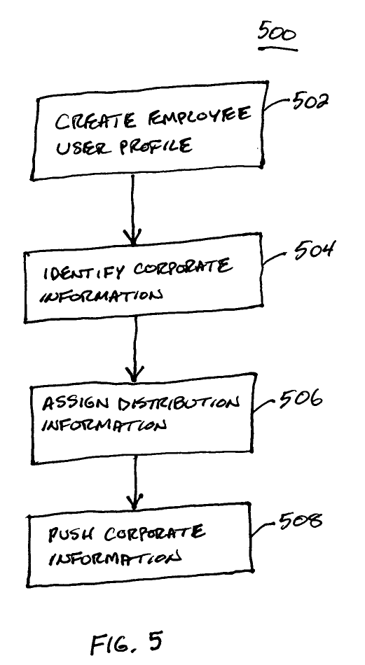

FIG. 4 is a block diagram of exemplary modules 400 for use in managing and controlling corporate information being pushed to employees. The modules 400 may include a corporate information collection module 402, corporate information search module 404, corporate information assignment module 406, corporate information push module 408, and corporate information rules module 410. It should be understood that these modules are exemplary and that such and/or different modules may be utilized in accordance with the principles of the present invention.

The corporate information collection module 402 may be used to collect corporate information from within a company and externally from third parties. The corporate information collection module 402 may be configured to operate as a content management tool in which additional information, such as identifiers, titles, authorship, format, and other information may be assigned to or associated with the corporate information. For example, a date of receipt and date of publication may be associated with corporate information. Furthermore, each “piece” of information may be assigned a title or other identifier that identifies the corporate information for search, sort, or other purposes. The corporate information collection module 402 may also be utilized to interact with a data repository for storing and managing the corporate information (i.e., content) in the data repository.

The corporate information collection module 402 may further be utilized by an operator of a system that prepares the corporate information for distribution to employees. In one embodiment, a user may assign individual employees, departments, groups, or any other identifier associated with an employee or group of employees, such as “new employee,” such that the corporate information is pushed to each of the employees that meet the criteria (e.g., Department A) associated with employees.

The corporate information search module 404 may utilize conventional search techniques for searching titles, indicia, content, or other parameters associated with corporate information. The corporate information search module 404 may present a user interface for a searcher to enter key word terms, dates, or any other parameter associated with corporate information. In one embodiment, the corporate information search module 404 may search html, metatagged data feeds, headlines, or any other internal or external information associated with the corporate information stored in the data repositories.

The corporate information push module 408 may be an application or module that is configured to utilize push technology for distributing corporate information to employees. The corporate information push module 408 may be an RSS module that is used to distribute information to each of the employees as filtered by the corporate information push module 408 or at each employee application that displays the corporate information. In other words, a filter maybe used to sort the corporate information being pushed to employees by examining assignment information, such as department, group, time of employment, or any other parameter that may be used to distinguish to which employees the corporate information is to be communicated.

The corporate information rules module 410 may be a software module that is used to apply rules for collecting and/or distributing corporate information. The corporate information rules module 410 may use business rules that define types of corporate information to be collected, types of information to be distributed, times at which corporate information are to be distributed, particular events that trigger corporate information to be distributed, or any other rule that a company may wish to use in collecting or distributing the corporate information.

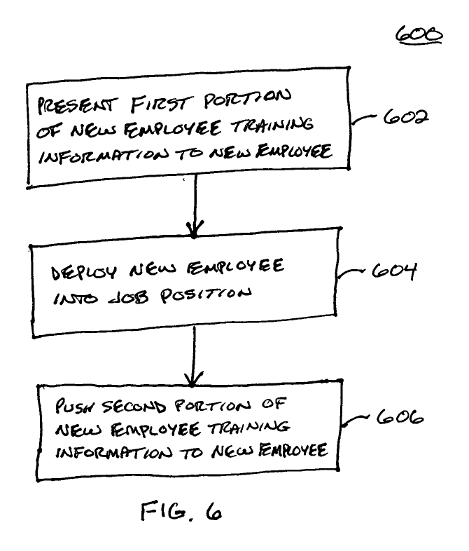

FIG. 5 is a flowchart of an exemplary process 500 for pushing corporate information to employees. The process 500 starts at step 502, where an employee user profile is created. The employee user profile may include a variety of demographic information and/or employee information that may be used in distributing corporate information to each employee. For example, time of service, gender, department, group, employee number, or any other employee profile information may be created. The employee user profile may be stored in the same or different data repository as corporate information is stored. At step 504, corporate information maybe identified. In identifying the corporate information, the information may be identified from internal or external sources. The identification may be performed manually (e.g., user generated), semi-automatically (e.g., search engine), or automatically using a software program (e.g., monitoring search service). An internal source may be an employee of the company that generates user manuals, new pricing lists, or any other corporate information that may be relevant to one or more other employees in performing their job functions. The identified corporate information may also be stored in a corporate information database.

Distribution information may be assigned to the corporate information at step 506. In assigning the distribution information, a user may enter or otherwise select one or more individuals, job position (e.g., engineering, customer service, etc.), groups, departments, or any other demographic or employee information that may be used for distributing the corporate information to employees. It should be understood that assignment of the corporate information to a department, group, or other collection of employees may be considered a job position. For example, the user may select or assign a “new user” identifier with the corporate information, such that the corporate information is pushed to new employees, where a new employee may be defined as an employee who has recently joined the company (e.g., within the past month). The definition of being a new employee may vary based on employee job type, employee skill level, company rules, or any other objective or subjective rule. At step 508, the corporate information may be pushed to employees based on the employee user profile or other parameters to which employees the corporate information is to be distributed. For new employees, the corporate information may include on-the-job performance support tools.

FIG. 6 is a flowchart of an exemplary process 600 for training new employees. The process starts at step 602, where a first portion of new employee training information may be presented to a new employee. The first portion of new employee training information may include general new employee training information in an overview of one or more particular aspects of a new employee's job. For example, the first portion of training information may include identification of different software packages and an overview of the software packages on which the employee will be working. At step 604, the new employee may be deployed into his or her job position. Because additional training will be provided to the new employee using push technology, the new employee may be deployed in less time than was traditionally possible. In deploying the new employee into his or her job position, the new employee may be given a desk or station at which to work and the tools (e.g., software) that the new employee is to use for his or her job tasks are provided.

At step 606, a second portion of new employee training information is pushed to the new employee. The second portion of the new employee training information may include details of the tools that the new employee is to use. In other words, while the new employee received and was presented the first portion of the new employee training information at step 606, a more detailed presentation of the new employee training information (i.e., corporate information) may be presented to the new employee so the new employee can spend less time in corporate training and more time on “on the job” training at his or her work location. By minimizing time that a new employee is to spend in training, the company may maximize work production of new employees by minimizing training time, as the new employee receives additional and more detailed training through the use of distributing the corporate information to the new employee via push technology. In one embodiment, the corporate information may be a video, graphic, simulation, text, audio, and/or other communication representation that is displayed in a push interface region of his or her computer and the new employee may view the corporate information while at his or her work location.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A method for communicating corporate information to employees of a company, said method comprising:
creating an employee user profile that includes an identifier of a job position of the employee within a company;
identifying corporate information to be communicated to employees of the company;
assigning distribution information to the corporate information, the distribution information including an identifier associated with at least one job position to communicate the corporate information; and
pushing the corporate information to employees associated with the distribution information, the pushed corporate information causing the corporate information to be presented to the employee.

2. The method according to claim 1, wherein creating the employee user profile that includes the identifier of a job position includes assigning a department in which the employee is assigned.

3. The method according to claim 1, wherein identifying corporate information includes identifying training information for new employees.

4. The method according to claim 3, wherein identifying training information includes identifying information to describe software that the employee is to use in performing his or her job.

5. The method according to claim 1, wherein pushing the corporate information includes using a really simply syndication (RSS) technology.

6. The method according to claim 1, wherein assigning distribution information includes filtering the corporation information based on a set of rules.

7. The method according to claim 6, wherein filtering the corporate information includes performing a word search to determine whether the employee information would benefit the employee on the employee user profile.

8. The method according to claim 1, wherein identifying corporate information includes identifying new product or service information provided by the company.

9. A method for training new employees, said method comprising:
presenting a first portion of new employee training information to a new employee in an organized classroom setting;
deploying the new employee into a job position; and
pushing a second portion of a new employee training information to the new employee to complete training the new employee.

10. The method according to claim 9, wherein pushing the second portion of new employee information includes distributing the new employee training information using push communication technology to a computer used by the new employee.

11. The method according to claim 9, wherein distributing the new employee training information using push communication technology includes using RSS communication technology.

12. The method according to claim 9, wherein presenting a first portion of new employee training information includes presenting general information of job function and software to be used in performing the job function.

13. The method according to claim 12, wherein presenting a second portion of new employee training information includes presenting more detailed information about job function and software to be used in performing the job function than the general information.

14. The method according to claim 9, further comprising assigning the new employee training information to new employees for pushing to the new employee.

15. A system for communicating corporate information to employees of a company, said system comprising:
a communications network configured to communicate corporate information to employees within a company;
a corporate information database configured to store corporate information;
an application server in communication with said communications network and said database; and
a push communication application executed by said server, said push communication application configured to access corporate information stored in said corporate information database and push the accessed corporate information to selectable employees within the company for display thereto.

16. The system according to claim 15, wherein said corporate information database is configured to store employee information associated with each employee, wherein the employee information includes time of service of employees at the company, organizational position of each position, and corporate information.

17. The system according to claim 16, wherein said push communication application is configured to filter corporate information to be pushed to employees selected based on organizational position.

18. The system according to claim 16, wherein said push communication application is configured to filter corporate information to be pushed to employees based on time of service.

19. The system according to claim 15, further comprising a search module configured to search corporate information for key words to identify the corporate information as being relevant for particular employees.

20. The system according to claim 15, further comprising a graphical user interface operating on an employee computing system, said graphical user interface displaying the corporate information without interaction by the employee.
